(19) United States
(12) Patent Application Publication
(10) Pub. No.: US 2021/0204759 A1
(43) Pub. Date: Jul. 8, 2021

(54) TACO COOKING INSERT

(71) Applicants: Diane Marie Guarino, Summerville, SC (US); Joseph De Masi Guarino, Summerville, SC (US)

(72) Inventors: Diane Marie Guarino, Summerville, SC (US); Joseph De Masi Guarino, Summerville, SC (US)

(21) Appl. No.: 17/140,878

(22) Filed: Jan. 4, 2021

Related U.S. Application Data
(60) Provisional application No. 62/956,704, filed on Jan. 3, 2020.

(51) Int. Cl. A47J 43/18

(52) U.S. Cl. CPC A47J 43/18

(57) ABSTRACT

A cooking insert for use with a taco shell having a pair of side portions defining an interior, including a bottom wall having an elongated front edge and an elongated rear edge, a front wall extending upwardly from the front edge of the bottom wall, and a rear wall extending upwardly from the rear edge of the bottom wall, wherein the front wall and the rear wall define an acute angle therebetween, and the cooking insert is disposed within the interior of the taco shell.

### CLAIM OF PRIORITY

This application claims priority to U.S. provisional patent application No. 62/956,704 filed Jan. 3, 2020, the disclosure of which is incorporated by reference herein.

### FIELD OF THE INVENTION

The present invention relates generally to cooking devices. More particularly, the present invention relates to cooking devices that assist in the heating of taco shells and like food items.

### BACKGROUND OF THE INVENTION

When preparing tacos or similar food items requiring a shell, it is desirable to heat the shell prior to inserting the food items therein. Frequently, the taco shells are placed on one side and heated in an oven on a baking sheet or similar plate. Too often, the sides of the taco shells move close to each other, or “collapse”, as they are heated. Additionally, the taco shells become more stiff, as is the point of heating the shells. However, the decreased flexibility of the shells hinders moving the sides of the shell apart from each other so that the ingredients may be inserted therein. As well, the decreased flexibility of the shells all too often leads to breakage of the shells rendering them unusable.

The present invention recognizes and addresses considerations of prior art constructions and methods.

### SUMMARY OF THE INVENTION

One embodiment of the present disclosure provides a cooking insert for use with a taco shell having a pair of side portions defining an interior, including a bottom wall having an elongated rear edge, a front wall extending upwardly from the front edge of the bottom wall, and a rear wall extending upwardly from the rear edge of the bottom wall, wherein the front wall and the rear wall define an acute angle therebetween, and the cooking insert is disposed within the interior of the taco shell.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which;

FIGS. 1A and 1B are top and side views, respectively, of a taco cooking insert in accordance with the present disclosure;

FIGS. 2A and 2B are side and top views, respectively, of the taco cooking insert shown in FIG. 1, inserted in a taco shell;

FIGS. 3A and 3B are top and front views, respectively, of a taco cooking insert in accordance with the present disclosure;

FIGS. 4A and 4B are top and front views, respectively, of an alternate embodiment of a taco cooking insert in accordance with the present disclosure; and

FIGS. 5A and 5B are top and side views, respectively, of an alternate embodiment of a taco cooking insert in accordance with the present disclosure.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

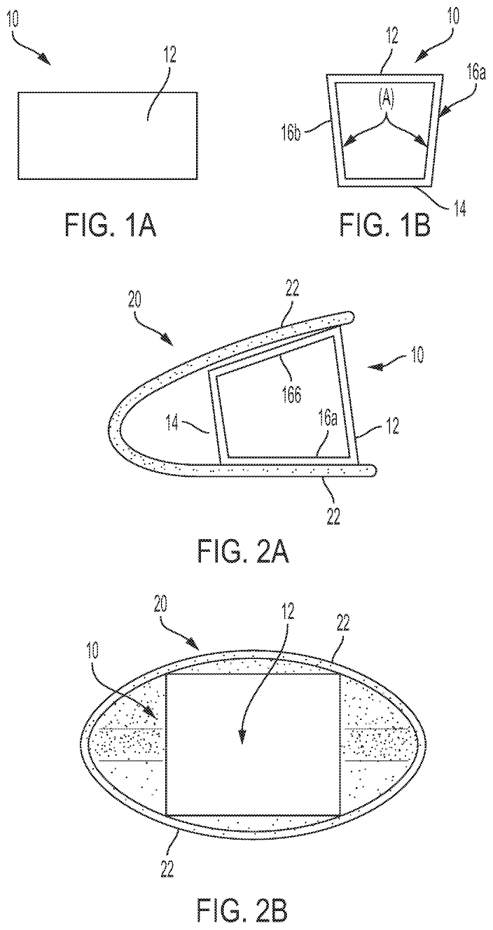

As used herein, terms referring to a direction or a position relative to the orientation of the multi-function lawn tool, such as but not limited to “vertical,” “horizontal,” “top,” “bottom,” “above,” or “below,” refer to directions and relative positions with respect to the taco cooking insert's orientation shown in FIGS. 1A and 1B. Thus, for instance, the terms “vertical” and “top” refer to the vertical orientation and relative upper position in the perspective of FIGS. 1A and 1B, and should be understood in that context, even with respect to a multi-function lawn tool that may be disposed in a different orientation.

Further, the term “or” as used in this application and the appended claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “and” as used in this application and the appended claims should generally be construed to mean “one or more” unless specified otherwise or clear from the context to be directed to a singular form. Throughout the specification and claims, the following terms takes at least the meanings explicitly associated herein, unless the context dictates otherwise. The meanings identified below do not necessarily limit the terms, but merely provide illustrative examples for the terms. The meaning of “a,” “and,” and “the” may include plural references, and the meaning of “in” may include “in” and “on.” The phrase “in one embodiment,” as used herein, does not necessarily refer to the same embodiment, although it may.

Referring now to the figures, an embodiment of a taco cooking insert 10 in accordance with the present disclosure is shown in FIGS. 1A and 1B. As shown, taco cooking insert 10 includes a top wall 12 and a bottom wall 14, that are connected at their peripheral edges by a pair of front and rear walls 16a and 16b. Preferably, the top wall 12 and bottom wall 14 are substantially parallel to each other, with the top wall 12 being slightly wider from front to rear than the bottom wall 14, as best seen in FIG. 1B. This insures that the front and rear walls 16a and 16b that connect the top wall 12 and bottom wall 14 form an acute interior angle (A), similar to the angle formed between the side walls 22 of a common taco 20, as best seen in FIG. 2A. As such, the taco cooking insert 10 fits nicely between the side walls 22 of the corresponding taco 20, as shown in FIGS. 2A and 2B, so that the side walls 22 remain separate during a heating process. Preferably, the taco cooking insert 10 is constructed of a food grade material, such as a metal, plastic, ceramic, polymer, etc., that is approved by authorities for use in food preparation.

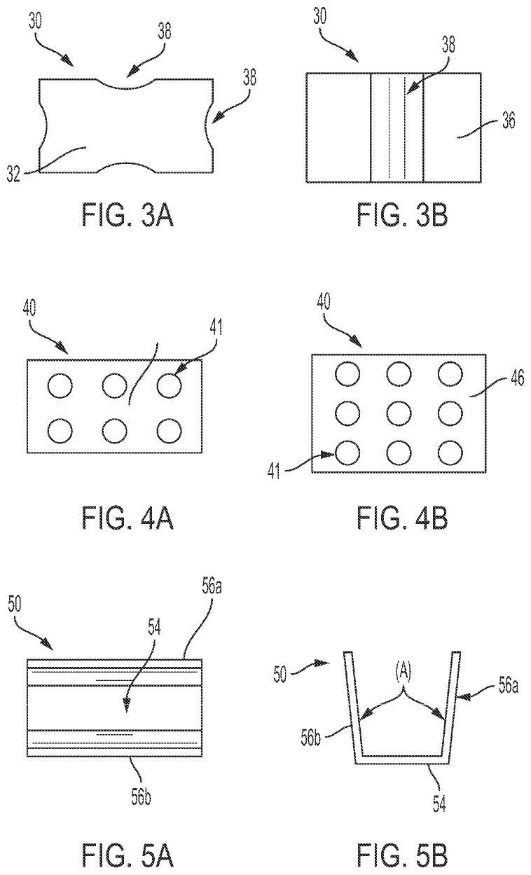

Referring now to FIGS. 3A and 3B, an alternate embodiment of a taco cooking insert 30 is shown. Taco cooking insert 30 differs primarily from the previously discussed embodiment in that recesses 38 are provided at the edges of top wall 32 to facilitate grasping the insert during insertion into, and removal from, a corresponding taco. As best seen in FIG. 3B, the recesses 38 adjacent the front and rear walls 36 may extend the entire height of the walls, thereby forming elongated grooves therein. As shown in FIGS. 4A and 4B, yet another embodiment of a taco cooking insert 40 includes perforations 41 formed in one, or all of, the top wall 42, front and rear walls 46, and bottom wall.

Referring now to FIGS. 5A and 5B, another embodiment of a taco cooking insert 50 has only a bottom wall 54, and front and rear walls 56a and 56b that extend upwardly therefrom, defining an acute angle (A) therebetween. During heating operations, taco cooking insert 50 may either be inserted into the taco, as with the previously discussed embodiments, or the taco may be positioned within the taco cooking insert 50 so that the taco is maintained in a vertical orientation during heating. As well, the taco cooking insert 50 may be used to maintain the taco in a vertical orientation while filling the shell with ingredients and serving the taco to the consumer.

While one or more preferred embodiments of the invention are described above, it should be appreciated by those skilled in the art that various modifications and variations can be made in the present invention without departing from the scope and spirit thereof. It is intended that the present invention cover such modifications and variations as come within the scope and spirit of the appended claims and their equivalents.

1. A cooking insert for use with a taco shell having a pair of side portions defining an interior, comprising:
a bottom wall having an elongated front edge and an elongated rear edge;
a front wall extending upwardly from the front edge of the bottom wall; and
a rear wall extending upwardly from the rear edge of the bottom wall,
wherein the front wall and the rear wall define an acute angle therebetween and the cooking insert is disposed within the interior of the taco shell.

2. The cooking insert of claim 1, further comprising a top wall that extends between an uppermost edge of the front wall and an uppermost edge of the rear wall.

3. The cooking insert of claim 1, wherein one of the bottom wall, the front wall, and the rear wall defines at least one aperture therein.
